(19) United States
(12) Patent Application Publication
(10) Pub. No.: US 2014/0108267 A1
(43) Pub. Date: Apr. 17, 2014

(54) Networking method for restricted communications

(71) Applicant: Jeffrey Wayne Bergosh, Pensacola, FL (US)

(72) Inventor: Jeffrey Wayne Bergosh, Pensacola, FL (US)

(21) Appl. No.: 13/987,895

(22) Filed: Dec. 20, 2013

Related U.S. Application Data
(60) Provisional application No. 61/700,411, filed on Sep. 13, 2012.

(51) Int. Cl. G06Q 50/26; G06Q 10/10

(52) U.S. Cl. CPC G06Q 50/26; G06Q 10/101
USPC 705/300

(57) ABSTRACT

The present invention is a computer implemented, internet website based method for idea development and subsequent sharing, networking, and best practices dissemination through a unique segregation method; construction of which is specifically intended to maximize, streamline, and expedite communications and transparency by and between individual members of governmental boards and commissions subject to locally implemented public record and open meeting laws, while at the same time preventing users from violating such existing laws which could lead to criminal prosecution and incarceration.

### BACKGROUND OF THE INVENTION

The present invention is in the technical field of computer implemented, internet website-based peer to peer, peer to general public networking.

### SUMMARY OF THE INVENTION

The present invention is a computer implemented, internet website based method for idea development and subsequent sharing, networking, and best practices dissemination between and among elected or appointed constitutional officers (or non-constitutional officer members of boards, commissions, committees or councils) subject to public records laws and open meeting or “sunshine” laws, (which may have criminal consequences if violated) their constituents, and others interested in public policymaking. This specific, computer implemented internet website based method will facilitate an open dialogue between individual members of governmental bodies and the general public, while compartmentalizing and segregating specific content on one platform (as opposed to regulating already constructed ideas for dissemination outward to multiple sites, platforms, or destinations electronically) to protect public officials from inadvertent violations of criminal statutes and the concomitant penalties imposed by such open records laws. This unique system of the present invention will be implemented through multiple specific, innovative processes which will impose restricted admission protocols on users prior to the entry and interaction of, by, and/or between such persons subject to open meeting laws, as a filtering method imposed on such users prior to the creation, development, and sharing of ideas. The process will be described in detail herein.

Traditional networking websites and networking methods allow for participation by everyone; however, elected officials, school boards, county commissions, city councils, advisory committees and other similarly situated individuals and members of such governmental bodies, and at times other organizations, are precluded from interacting with peer members of their same governmental body outside of advertised, highly structured, time-sensitive, open and accessible public meetings, with possible criminal penalties for violations. These criminal penalties severely limit open discussion of ideas and create inefficiency. Additionally, any written or electronic communication generated by members of such governmental bodies associated with their official duties (Personally Identifiable Information excepted) are also subject to open meeting laws and their criminal penalties and are required to be made available for public inspection if requested under any one of the various public records laws nationwide. From the standpoint of public records, the computer implemented, internet website based method of the present invention described herein will be in full compliance with any and all open records laws; all written content, even moderated or filtered content, generated by any public official subject to any open records statute, will be accessible and can be easily requested by any person, for any reason, world-wide, any time. This site will facilitate open and meaningful dialogues between public officials through innovative computer implemented processes will protect such persons from the chilling, criminal penalties of arcane, punitive open meetings laws. This site will be completely transparent, which will mean all public records generated on the site will be available on the site. Because of the way in which this innovative, computer generated website process will explicitly adhere to public records/documents requests innately by the way in which it is constructed, the balance of the description below will focus on the specific aspects of this computer implemented website based method's compliance with applicable open meeting laws. In addition to public records/documents laws, all fifty states and the District of Columbia have open meeting laws on the books. While nuanced variations between these laws exist from state to state, the main commonality between all of the open meetings laws is the requirement that open, accessible meetings be held in public. Additionally, these laws mandate that boards, committees, commissions, and councils that engage in government policymaking and governance advertise and or publicly notice constituents of such governmental bodies' meetings in advance of such meetings. Publication of Agendas in advance is another requirement common to various states' open meeting laws. The innovative processes of the present invention will protect public officials from inadvertent violations of criminal laws while simultaneously allowing for the most robust dissemination of ideas possible under current law in order to foster efficient administration of government.

The first state in the nation to enact such open meeting legislation was the state of Florida, in 1967. According to the Reporters Committee for Freedom of the Press, which maintains a database of all 51 statewide open meeting laws (http://www.rcfp.org/open-government-guide) Florida's open meeting laws (Chapters 119 and 286, FL Stat.) are the most expansive in the United States of America. These laws are criminal in nature, and punitive in nature and have and can result in the incarceration of public officials for inadvertent violations. The extreme possible punitive punishments of these laws creates cumbersome, glacially slow transmission of ideas between governmental bodies. The innovative invention described herein removes these barriers while following these laws and protects and insulates members of governmental entities from inadvertent violations of these criminal laws that can result in the incarceration of public officials. The State of Florida's open meeting “Government in the Sunshine” law is used herein as an exemplitive model against which the efficacy of the computer implemented, internet website based method for idea sharing of the present invention is and/or can be assessed regarding explicit compliance with the strict provisions of these Florida statutes as well as other state's open meeting laws.

Potential criminal sanctions inherent with open meetings laws create communication limitations on members of governmental bodies that include the following:

1. Discussions through any medium between one or more members of such a governmental body outside of legally advertised open meetings can be broadly construed as a meeting if the subjects discussed include matters which are coming before such a board or may be reasonably assumed to be coming before such a board for action. This limits the spectrum of subjects that individual members of one board may discuss with their peers on the same board outside of open meetings.

2. Due to public perception, one or more members of the same board subject to open meeting requirements naturally avoid communicating with one another in public, for fear of being wrongly accused of meeting outside of an advertised, open public meeting, even if subjects contemplated for discussion are not issues or ideas subject to open meeting laws.

3. Open meeting laws mandate meeting agendas be published in advance of open, public meetings; This limits and restricts what boards as a whole, and individual members of such boards, in particular, may discuss during bona fide, open public meetings, which has the effect of imposing significant restrictions on what can be discussed as ideas develop and are contemplated for discussion after such agendas are published.

4. Open meetings are typically highly structured and time sensitive, preventing extemporaneous, fluid, and extended discussions that are imperative to efficient operation of government.

5. Open meetings are infrequent, leaving long periods of time between such meetings where individual members are essentially cut-off from discussing topics with their peer members on such boards about issues which may be relevant and arise between open, advertised public meetings.

6. The isolation imposed by the restrictive nature of criminal, punitive open meeting laws on small governmental bodies has the unintended consequence of weakening such boards by stymieing idea sharing between members, often leading to decisions being made without all members hearing the opposing views or the supporting views of other members of such boards before action is taken.

7. Open meeting laws restrict opposing viewpoints of members of such boards if those members do not have the chairmanship of such board; Chairmen of boards have the ability to call and schedule open, advertised meetings, but other members do not have this power.

8. Best practice dissemination between two members of the same board is restricted by proxy due to criminal, punitive open meeting laws, as one member would be reluctant to share a best practice idea or concept of which that board member was aware with another member of his/her same board outside of a legally advertised, highly structured and time sensitive meeting, because such a topic would naturally be a subject that could reasonably assumed to be coming before an entire board for action, and could lead to criminal conviction and incarceration.

9. Agency heads, e.g., superintendents of schools, county administrators, mayors, city administrators, or other such individuals, hold undue influence over and wield great leverage over the boards, councils, committees and commissions by which they are supervised, due to the unintended, restricted communication environment created by open meeting laws. For example, if a position or policy is favored by an agency head but individual board members subject to open meeting laws are not necessarily in agreement or are divided over such a policy, individual agency heads have the luxury of being able to meet individually with members of such boards or other agency heads discuss, lobby or ascertain support, which subverts the balance of power of the respective duties of boards and agency heads. This environment allows agency heads an unequal advantage and edge with respect to knowing in advance what the overall position of the entire board might be. Individual board members subject to open meeting laws cannot have such meetings with their peers, and therefore do not know positions of their peers prior to action being taken. All of this results in less efficient and effective government for citizens.

10. Open meeting laws preclude any communications between members of an individual board via any third party (conduit) on issues which may come before the board as a whole, which severely limits communications among the general public and members of elected boards. Traditional website-based methods and vehicles for networking have diminished effectiveness for members of governmental bodies that are subject to open meeting laws, as the constant fear of accusations of breaking the open meeting laws precludes members of small boards from communicating at all outside of open meetings.

11. Open meeting laws stymie communications between individual members of the same board when one member of a board or commission has knowledge of a best practice or great idea, wants to share the idea, but is hesitant to do so for fear of eliciting a reply which could be considered a meeting. Such conditions limit the dissemination of great ideas between similarly situated boards, commissions, councils, and committees nationwide leading to an environment of restricted idea sharing and best practice dissemination.

Some internet communications that work well for the general public but that are problematic for boards, councils, commissions, and other bodies subject to open meeting laws are the following:

1. Emails sent and received via the internet are wonderful tools, however if a board member sends emails to another board member, such communication can come under scrutiny if the subject discussed comes before the board as a whole for a vote. Additionally, an inadvertent “reply to all” via email could result in criminal prosecution and incarceration, if a peer board member was copied on the original email, as such a reply could be construed as a meeting outside of open meeting laws.

2. Social media internet sites do not provide filtering for member content between members of boards or commissions subject to open meeting laws, so two or more members of the same board or commission subject to open meeting laws cannot network in the same “groups” on social media sites for fear of an inadvertent violation of open meeting laws, which would subject these individuals to criminal sanctions. Members of such boards cannot receive information from other members of the same board via any third party (conduit) without violating open meeting laws, and because groups and individuals on the various social meeting sites are unaware of the implications of open meeting laws and their potential culpability (as third-party conduits between two members of a same governmental body) under these laws, and because ideas and topics flow fluidly, the risk of a violation, accidental, inadvertent, or purposeful is very real. This climate essentially precludes more than one member of a same board, commission, council or committee subject to open meeting laws from being a member of the same group on a social media site. The result is that oftentimes board members that serve with peers on the same boards, commissions, councils, or committees do not know what subjects, topics, or research their peers are engaged in and working on, due to the communications limitations imposed on members of such boards, councils, commissions, or committees by the very nature of open meeting laws.

3. Message boards exist for many professionals and tradesmen on the internet, however this traditional method of requesting and giving information and answers to questions between similarly situated career professionals has limited benefit to multiple members of a same board or commission subject to open meeting laws, as participation by more than one board member from the same body on the same message board could be construed as a meeting outside of the public view and therefore a violation of open meeting laws. In addition to this limitation, many message boards are so locally focused and centered, that finding such a group message board that would fulfill the needs of an individual board member but simultaneously not violate open meeting laws would be difficult if not impossible.

4. Responding to comments on blogs or blog posts is a method of communication which the public enjoys, however if more than one member of a board or commission subject to open meeting laws wish to participate by commenting on such blog posts, and if the comments refer to a subject which will come or may reasonably be expected to come before the body as a whole to act upon, such communication could be construed as a violation of open-meeting laws. This atmosphere, overall, creates an environment where individual members of aforementioned types of governmental bodies become isolated and are hampered in their utilization of any one of the plethora of available social media websites for idea sharing and networking, for fear of running afoul of one or more of the various state-enacted open meeting laws. The computer implemented, website based method for idea sharing, networking, and best practices dissemination between and among governmental bodies subject to open meeting or “sunshine” laws of the present invention described herein and under this patent application addresses this situation by allowing all members of specific individual boards to communicate and network between one another, in an open and transparent manner via multiple methods all web site-based, to the maximum extent permissible, without violating state enacted open meeting laws, thus fostering greater transparency and enhanced efficiency among such bodies locally, nationwide, and worldwide.

The following aspects of the present innovative invention will provide solutions to the limitations and criminal sanctions discussed and described previously:

1. The construction of the innovative computer implemented, internet website method of idea sharing and networking among government bodies subject to open meeting laws of the present invention will require registration of all participants and also will require that any member of a board or commission subject to open meeting laws identify this fact at registration as well as what specific board or commission of which the registrant is a member. The innovative software design of the site will prohibit more than one member of any one same board or commission from actively commenting back and forth (which prevents criminal violations), while at the same time allowing ALL members of the same board the ability to see questions and answers from around the world in real time. Only one member of the same board or commission will have the ability to post and reply in back and forth fashion, other members of that same board or commission will have “read-only” access.

2. The construction of this innovative, computer implemented website method of the present invention will have a “one way” communication feature, viewable and available for all to participate in (which will allow for all ideas to be shared by and between every member of every board or commission in the United States of America and Worldwide, which will greatly enhance the efficiency of such boards via a rapid dissemination of best practices) the likes of which currently does not exist anywhere else in the world. The particular construction of this portion of the computer implemented, internet website based networking method of the present invention will prevent participating members from violating criminal, punitive open meeting laws by strictly limiting the type of discourse permitted, namely only one-way statements will be permitted. No discourse or back and forth will be allowed in this section; second hand opinions will not be allowed, and the opinions, thoughts, or ideas of other individuals will not be allowed. Topic jumping or discussing topics previously discussed in other portions of the site will not be permitted. Email addresses will be allowed to be included in these one-way posts, so that interested members of the public and other board members from other areas can contact posters. Prior to being viewable live on the web site, such posted one way ideas will be subject to moderation, as an additional safeguard against an inadvertent open meeting law violation. All content posted to this section of the site will be maintained in perpetuity and subject to public records requests as applicable.

3. The construction of this computer implemented website method will have a “one way” communication feature, viewable and available for all to participate in, which will allow for news links to be shared by and between every member of every board or commission in the United States of America and worldwide. The particular construction of this portion of the computer implemented, internet website based networking method of the present invention will prevent participating members from violating open meeting laws by only allowing links to news items to be posted. Prior to being viewable on the site, such posted links will be subject to moderation, and all content posted to this section of the site will be maintained in perpetuity and subject to public records requests as applicable.

4. The particular construction of this innovative, computer implemented, internet website based networking method of the present invention will have a “one way” communication feature, viewable and available for all to participate in, which will allow for links of interest to be shared by and between every member of every board, council, committee, or commission in the United States of America and worldwide. The construction of this portion of the site will prevent participating members from violating open meeting laws by only allowing links to sites of interest to be posted. Prior to being viewable live on the site, such posted links will be subject to moderation, and all content posted to this section of the site will be maintained in perpetuity and subject to public records requests as applicable.

The innovative computer implemented, internet website-based method for idea sharing, networking, and best practices dissemination between and among governmental bodies subject to open meeting or “sunshine” laws, their constituents, and others interested in public policymaking of the present invention, has the following benefits to the users:

1. Best ideas can be rapidly shared without violating punitive criminal open meeting statutes, preventing prosecution and possible incarceration of individual members of government bodies subject to such laws.

2. Similarly situated policymaking board members (without being subjected to criminal penalties for violating open-meeting laws) as well as individuals interested in policymaking nationwide or worldwide have an immediate method and process to air questions, solicit input, and share ideas-between the infrequent times that open, advertised meetings take place in their respective communities.

3. Members of boards, commissions, councils, committees or other governmental bodies subject to open meeting laws (and their concomitant criminal penalties) can gather data, insight, and advice from other similarly situated individuals nationwide and worldwide to augment their positions and ideas locally. Due to geographic limitations and the lack of a currently established computer implemented website method to enable and facilitate this type of discussion while protecting users from criminal sanctions, such information flow is presently impossible.

4. Multiple members of the same board can discern information about their peers (each other) more rapidly than waiting for participation in infrequent and highly structured, time-sensitive open meetings, by watching the conduct of their counterparts as they participate in various parts of the computer implemented website based method for idea sharing, networking, and best practices dissemination of the present invention while avoiding punitive criminal sanctions. Stated another way, the types of news links and informational website links one shares, or the types of big ideas one shares, or the discourse and positions espoused between other forum participants and peer members of a person's own board or commission provides information about that persons' beliefs, values, and/or specific positions on issues that may otherwise take years of once monthly meetings to divine.

5. The innovative, computer implemented internet website based method of the present invention enables the general public, and those interested in the policymaking and governance by small elected governmental boards to have expanded access to these representatives of their local governments, as well as additional opportunities to interact with these boards and individual board members, as the method of the present invention encourages participation by all without fear by the governmental board members of inadvertently violating criminally punitive open meeting laws.

6. Media coverage can focus more sharply on issues that matter to governmental boards, commissions, committees, and councils by watching the communication and activity between members of such governmental bodies and the general public contained in the different sections of the computer implemented website based method for idea sharing, networking, and best practices dissemination of the present invention.

### BRIEF DESCRIPTION OF THE DRAWINGS

FIG. 1 is a perspective view of the screen of the website component of the present invention as it would appear once accessed over the internet via a notebook (“laptop”) computer;

FIG. 2 is a flow chart depicting in detail the website-based method for information sharing via a two-way, back and forth “forum” section of the present invention of FIG. 1;

FIG. 3 is a flow chart depicting the website-based method for one way communication via “big idea” sharing and information disseminating which is a part of the method of the present invention.

FIG. 4 is a flow chart depicting the website-based method for information sharing via a “News Links” method of information sharing/disseminating which is a part of the method of the present invention.

FIG. 5 is a flow chart depicting the website-based method for information sharing via a “Links of Interest” method of information sharing/disseminating which is a part of the method of the present invention.

### DETAILED DESCRIPTION OF THE INVENTION

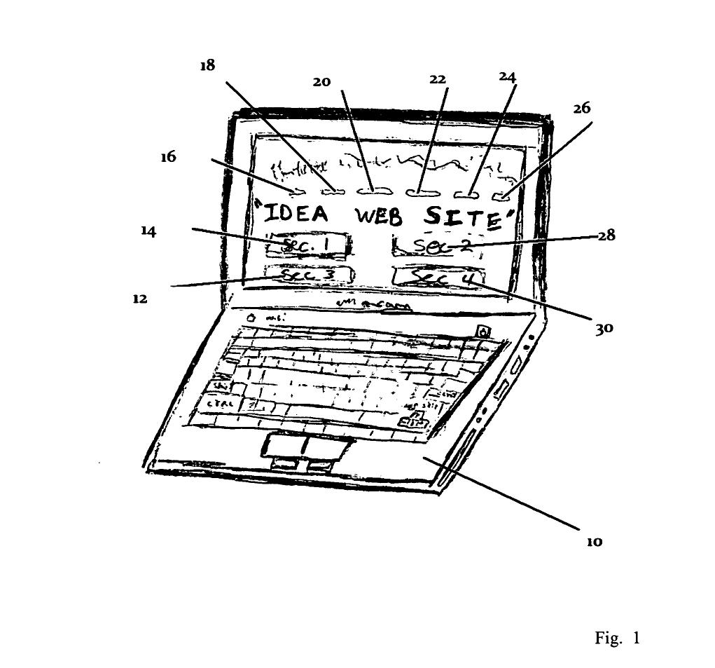

Referring now to the invention in more detail, in FIG. 1 there is shown a view of a website component of the present invention as it will appear on a traditional Personal Computer screen, Smart Pad Computer Screen, Notebook Computer screen 10, or Smart Phone Screen. The unique aspect of this invention is a computer implemented, internet website based method of interaction between members of governmental bodies subject to open meeting laws and the public, which protects members of governmental bodies from the severe criminal penalties contained in open meeting laws that unintentionally stifles speech and discourse that is necessary for the efficient administration of government business. The method is developed using an internet website constructed of open-sourced software, phpBB programming, or any other open source computer language programs. This innovative, computer implemented, website based method is comprised of multiple sections 16, 18, 20, 22, 24, 26 of multi-faceted interactive platforms 12, 14, 28, 30 designed for multiple forms of communication by and between members of the public and elected bodies subject to open meeting laws, combined with a precise method of utilization of the website based portions such that transparency is maximized by and between governmental boards subject to open meeting laws and the general public. Construction of this computer implemented website based method is specifically intended to maximize communication and transparency of governmental boards, councils, committees, and commissions, while at the same time preventing such users from inadvertently violating open meeting laws that are punitive in nature and subject members of governmental bodies to incarceration. Software provisions upon user registration and software programmed monitoring of the interactive user posts to include moderation of such posts prior to such posts being visible on the public website will explicitly prohibit users from unknowingly violating open meeting laws while utilizing this method. The distinguishing characteristic of this innovative, computer implemented, website based method of idea creation and dissemination as contrasted to the limited prior art in this arena is that this networking method herein prevents unauthorized, potentially criminal interaction between two or more individuals subject to open meeting laws prior to the creation or sharing of ideas between such individuals. The limited, previously patented prior art, a system of restricted communications in this arena (U.S. Pat. No. 8,341,754 B2 Robert C. Weir And Diane Weir) dealt with the transmission of already constructed ideas outward, after creation or development of such ideas.

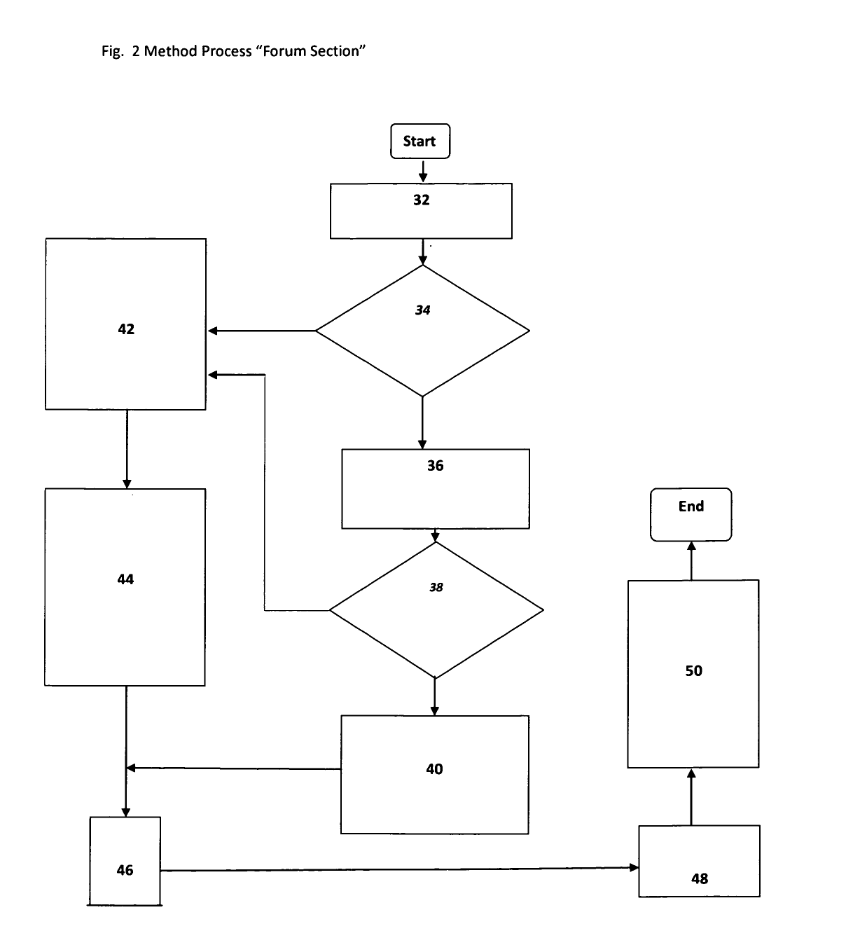

In further detail, still referring to a component section 14 of the invention rendering of FIG. 1 and now including FIG. 2, The flow chart illustrated in FIG. 2 is a graphic depiction of the process implemented in one part 14 of the present invention, allowing for the discourse and back and forth conversing between members of various public bodies subject to open meeting laws and their constituents and other members of the general public worldwide while through this invention protecting members of governmental bodies from exposure to punitive criminal sanctions including incarceration. At the start of this part of the process, registration 32, 34 is required by all users of the site. If the registrant is a member of a board, commission or council that is subject to open meeting laws, this fact is specified and registered and the specific board, council, committee, or commission on which the registrant serves is indicated 34. If the registrant is the first member or sole member of his/her particular board, council, committee, or commission to register on the site, then this first or sole member of such governmental body is granted “full access” 42 for the two-way, back and forth forum section of the site. If the registrant is the second or any subsequent member of the same governmental body, then registration is granted for “read-only” 40 access to the two-way, back and forth forum section of the site, again through this present invention, protecting initial and all subsequent members of same governmental boards from criminal prosecution. At the regularly scheduled, advertised meeting(s) of any board, commission, committee or council whose members participate in this forum, ideas to be put into the forum section by the first/sole member registered (with full access) can be legally discussed 44 by all members of such board, commission, committee or council. Issues legally discussed at such an open meeting can subsequently be entered into the forum section of the internet website by the one member of such board with “full-access” in order to rapidly elicit feedback from the online community worldwide 46. Registered “full-access” forum members and “read-only” members can all simultaneously monitor the forum and see responses in real-time 48. Registered “full-access” forum members can respond to posts, post replies, ask for additional clarification, and fully interact with all members of the online community worldwide 50. “Full-access” members can create new forum topics and respond to any other forum topics. “Read-only” members cannot post replies, post topics, or start new forum threads 50. Construction of the method in this fashion prevents two-way conversations outside of regularly advertised meetings between one or more members of the same boards, commissions, committees, or councils, thus preventing inadvertent violation of open meeting laws by forum participants. At the same time, construction of the method in this way maximizes participation by all members of a same governmental body subject to open meeting laws via the discussion of topics for inclusion in this forum section legally 44, 46 at open advertised regular meetings of such governmental bodies.

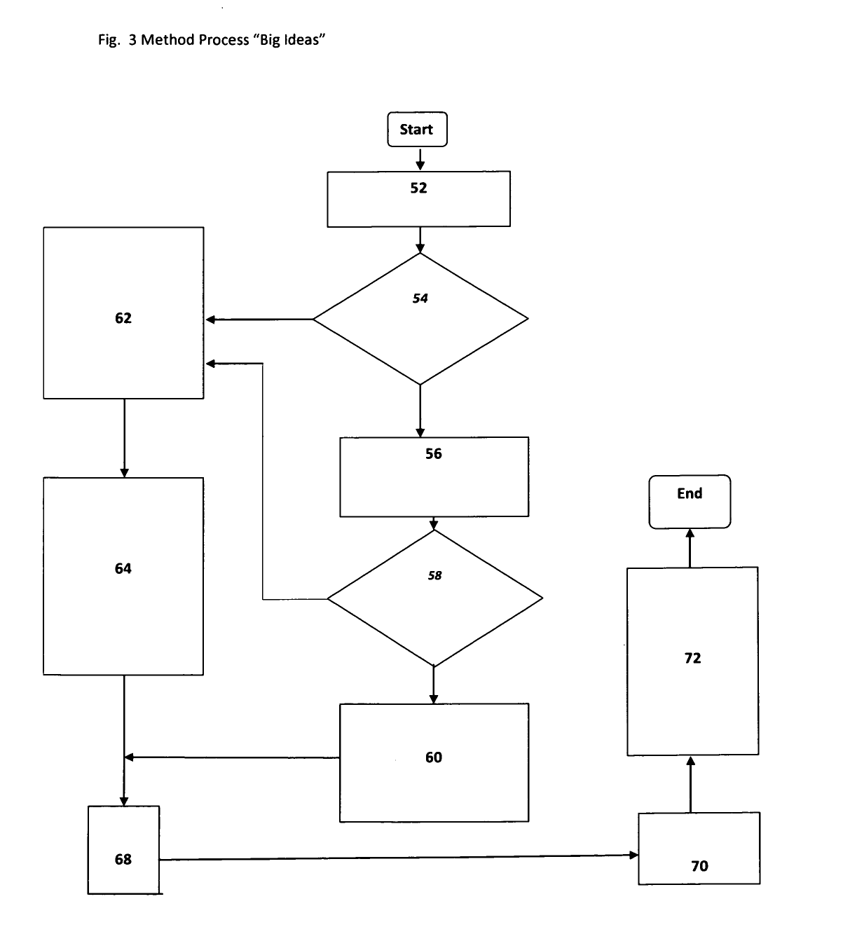

In further detail, still referring to the invention of FIG. 1 and now including FIG. 3, The flow chart illustrated in FIG. 3 is a graphic depiction of the process implemented in one part 28 of the method of the present invention, allowing for one way communication via idea sharing between all members of various public boards, councils, commissions, or committees subject to open meeting laws and their constituents and other members of the general public worldwide. At the start of this part of the process, registration 52, 54 is required by all users of the site. If the registrant is a member of a board, commission or council that is subject to open meeting laws, this fact is specified and registered and the specific board, council, committee, or commission on which the registrant serves is indicated 54, 56. Whether or not the registrant is the first member or sole member of his/her particular board, commission, or council to register on the site, all registrants are granted “full access” 60, 62 for the one-way, big idea sharing section of the site. At any time after registration, any registered individual can legally post big ideas for one way sharing with other similarly situated boards, commissions, and councils worldwide 64. Ideas added to this big idea section can be accessed by all of the online community worldwide, anytime, after such big idea posts are moderated for content by the site based software and or a human moderator and posted live on the internet via the website component method of the present invention. Questions are not permitted in this section, as this would potentially elicit responses which could then be construed as an unadvertised, non-public meeting under open meeting laws. Those who post one-way big ideas will be encouraged to provide contact information, an email address, or office telephone number within the body of their posted idea, so that other similarly situated individuals have a means to contact and communicate with such posters outside of the website 68, 70. This functionality allows all posters to fully network and interact with all members of the online community worldwide that are interested in learning more specifics about such big ideas, provided such persons do not serve on an identical governmental body 70. Individual members of the same board, commission, committee or council may only discuss big ideas presented online on the website described herein at regularly scheduled, open public meetings of such board, council, committee or commissions 72. Construction of the method in this fashion precludes two-way conversations between members of the same boards, commissions, or councils outside of regularly scheduled, advertised meetings, thus preventing inadvertent violation of open meeting laws by forum participants and associated criminal penalties.

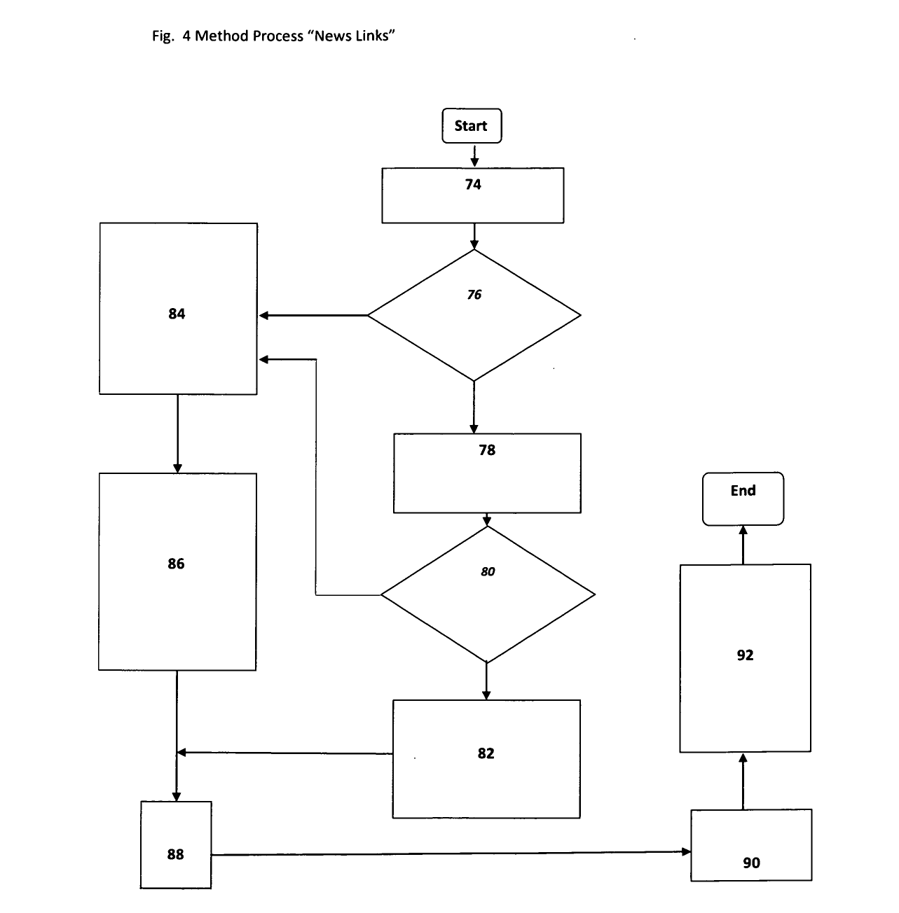

In further detail, still referring to the invention of FIG. 1 and now including FIG. 4, The flow chart illustrated in FIG. 4 is a graphic depiction of the process implemented in one part 12 of the present invention, allowing for one way communication via the posting of current events news links by all members of various public bodies subject to open meeting laws and their constituents and other members of the general public worldwide. At the start of this part of the process, registration 74, 76 is required by all users of the site. If the registrant is a member of a board, commission or council that is subject to open meeting laws, this fact is specified and registered and the specific board, council, committee, or commission on which the registrant serves is indicated 76, 78. Whether or not the registrant is the first member or sole member of his/her particular board, commission, or council to register on the site, all registrants are granted “full access” 82, 84 for the one-way, news links sharing section of the site. At any time after registration, any registered individual can legally post website hyperlinks to legitimate news stories for one way sharing with other similarly situated members of boards, commissions, committees, and/or councils worldwide 86. News links added to this section can be accessed by all of the online community worldwide, any time, after such linked posts are moderated for content 88 by the site based software and or a human moderator and posted live on the internet via the website component method of the present invention. Questions and comments are not permitted in this section, as this would potentially elicit responses which could be construed as a meeting under open meeting laws. Those who post news links will be listed as the contributor of such content, and the time and date of the posted link(s) contributed will be displayed along with the link 88, 90. Individual members of the same board, commission, committee or council may only discuss news links presented online on the website described herein at regularly scheduled, open public meetings of their individual board, council, committee or commission 90. Stories linked by members of the site are categorized chronologically and accessible to all members of the public 92. Construction of the method in this fashion precludes two-way conversations between members of the same boards, commissions, or councils outside of regularly scheduled, advertised meetings, thus preventing inadvertent violation of open meeting laws by forum participants, while encouraging members to contribute content which may be of interest to all who access the site.

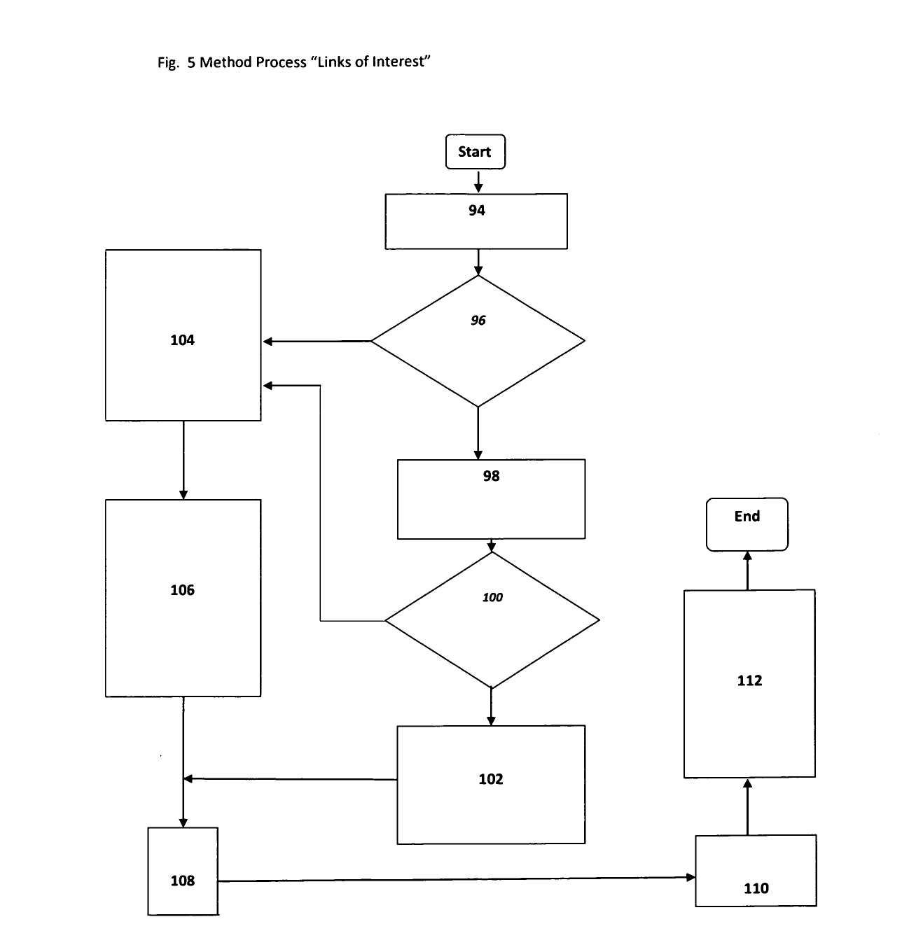

In further detail, still referring to the invention of FIG. 1 and now including FIG. 5, The flow chart illustrated in FIG. 5 is a graphic depiction of the process implemented in one part 30 of the present invention, allowing for one way communication via website links of interest sharing by all members of various public bodies subject to open meeting laws and their constituents and other members of the general public worldwide. At the start of this part of the process, registration 94, 96 is required by all users of the site. If the registrant is a member of a board, commission or council that is subject to open meeting laws, this fact is specified and registered and the specific board, council, committee, or commission on which the registrant serves is indicated 96, 98. Whether or not the registrant is the first member or sole member of his/her particular board, commission, committee or council to register on the site, all registrants are granted “full access” 102, 104 for the one-way, links of interest sharing section of the site. At any time after registration, any registered individual can legally post website hyperlinks to legitimate internet web sites of interest for one way sharing with other similarly situated members of boards, commissions, committees, and/or councils worldwide 106. Links of interest added to this section can be accessed by all of the online community worldwide 110, any time, after such site hyperlinks are moderated for content 108 by the site based software and or a human moderator and posted live on the internet via the website component method of the present invention. Questions and comments are not permitted in this section, as this would potentially elicit responses which could be construed as a meeting under open meeting laws. Those who post links of interest will be listed as the contributor of such content, and the time and date of the posted link(s) contributed will be displayed along with the link 108. Individual members of the same board, commission, committee or council may only discuss links of interest presented online on the website described herein at regularly scheduled, open public meetings of their individual board, council, committee or commission. 110. Websites linked in this part of the website method described herein are categorized chronologically and accessible to all members of the public 112. Construction of the method in this fashion precludes two-way conversations between members of the same boards, commissions, committees or councils outside of regularly scheduled, advertised meetings, thus preventing inadvertent violation of open meeting laws by forum participants, while encouraging members to contribute content which may be of interest to all who access the site.

The way in which the computer implemented internet website method for networking, idea development and sharing, and best practices dissemination of the present invention, described herein, complement each other and allow for idea sharing and greater transparency is illustrated below via a graphic representations and flowcharts. The advantages of the present invention include, without limitation, that it is accessible and exceedingly easy to utilize for rapid dissemination of ideas between and among governmental bodies subject to open meeting laws, while protecting such members of boards from criminal penalties. It is easy to access these methods via personal computer, laptop computer, smart phone, or tablet computer over the internet.

In broad embodiment, the present invention is a computer implemented, internet website based method for idea sharing utilizing a specific method and process while simultaneously protecting users subject to open meeting laws from criminal penalties associated with these laws.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

We claim:

1. A computer-implemented internet website based method for idea development and subsequent sharing, networking, and best practices dissemination between and among elected or appointed constitutional officers (or non-constitutional officer members of boards, commissions, committees or councils) subject to public records laws and open meeting or “sunshine” laws, (which may have criminal consequences if violated) their constituents, and others worldwide that are interested in public policymaking, comprising:

2. The method of claim 1, providing users of such site with a means of performing a first action of registering for access permission and utilization of such site, allowing for the posting of content to the website; allowing that if registrant is a member of a board, commission, council or any other entity that is subject to open meeting law, this fact is registered, so affirmed by the registrant, and the specific board, council, committee, or commission on which the registrant serves is documented, stored, and displayed.

3. The method of claim 1, providing a means such that if registrant is the first member or sole member of his/her particular board, council, committee, or commission to register on the site, this first or sole member of such governmental body is granted “full access” for a two-way, back and forth dialogue.

4. The method of claim 1, providing a means such that if registrant is the second or any subsequent member of the same governmental body, registration is granted for “read-only” access to a two-way, back and forth dialogue forum, through segmentation based upon the registration, protecting initial and any and all subsequent members of same or separate governmental boards from criminal prosecution for communicating back and forth outside of properly advertised, open meetings, while simultaneously allowing any member of the public and all members of any elected or appointed constitutional offices (or non-constitutional officer members of boards, commissions, committees or councils) subject to public records laws and open meeting or “sunshine” laws the ability to see, watch, read, and follow real time discussions.

5. The method of claim 1, providing for a computer-implemented internet website based method allowing for one way communication via the posting and sharing of website links of interest and news links by any members of any various public bodies subject to open meeting laws and their constituents and other members of the general public worldwide where questions and comments will not be permitted, as this would potentially elicit responses which could be construed as a meeting under open meeting laws. Those who post links of interest will be listed as the contributor of such content, and the time and date of the posted link(s) contributed will be displayed along with the link.

6. The method of claim 1, whereby all registration information, content added, ideas added, conversations depicted, and all communicated information added in any section of the site shall be stored in perpetuity and be made available for public dissemination to comply fully with public records laws.

7. The method of claim 1, providing a means for allowance of one way communication via idea sharing between all registrant members of various public boards, councils, commissions, or committees subject to open meeting laws and their constituents and other members of the general public worldwide, Whether or not registrant is the first member or sole member of his/her particular board, commission, or council to register on the site.

8. The method of claim 7, whereby ideas added to this section can be accessed by all of the online community worldwide, anytime, after such big idea posts are moderated for content by the site based software and or a human moderator and posted live on the internet via the website component method of the present invention, where questions shall not be permitted, as this would potentially elicit responses which could then be construed as an unadvertised, non-public meeting under open meeting laws.
